(19) United States
(12) Patent Application Publication
(10) Pub. No.: US 2019/0142133 A1
(43) Pub. Date: May 16, 2019

(54) Hair Dryer Support Device

(71) Applicant: William C. Smith, Marlborough, MA (US)

(72) Inventor: William C. Smith, Marlborough, MA (US)

(21) Appl. No.: 16/100,604

(22) Filed: Aug. 10, 2018

Related U.S. Application Data
(60) Provisional application No. 62/586,692, filed on Nov. 15, 2017.

(51) Int. Cl. A45D 20/12; F16M 11/12

(52) U.S. Cl. CPC A45D 20/12; A45D 2020/126; F16M 11/121

(57) ABSTRACT

A hair dryer support device. The hair dryer support device includes a base member that holds a vertical support rod in a vertical position. A bracket is attached to the vertical support rod opposite of the base member. The height of the vertical support rod is changeable by multiple vertical support members. The bracket includes a flexible member attached to the vertical support rod. The flexible member has a pair of circular support members to accommodate a hair dryer. The position of the hair dryer is changeable by movement of the flexible member.

### CROSS REFERENCE TO RELATED APPLICATIONS

This application claims the benefit of U.S. Provisional Application No. 62/586,692 filed on Nov. 15, 2017. The above identified patent application is herein incorporated by reference in its entirety to provide continuity of disclosure.

### BACKGROUND OF THE INVENTION

The present invention relates to a hair dryer support device. Currently available hair dryers or blow dryers require their users to hold the hair dryer in one hand while he or she is drying his or her hair. Thus while utilizing a hair dryer, a user will only have one free hand with which to use a styling tool, such as a hair brush or a bottle of hair spray. Because of the inefficiency of only utilizing one hand to style hair, hair dryer users are prevented from fully styling their hair as they wish to with their full skill or effectiveness.

Current devices are bulky and cumbersome and fail to provide their users with an easy way to transport their hair dryer stand. Furthermore, currently available hair dryer stands fail to provide a hair dryer support device that is collapsible, preventing users from being able to position their hair dryer stand as they may wish. Therefore, there is a need in the prior art for a hair dryer support device that provides a user with the convenience of two-handed hair styling while additionally providing ease of transportation of the device and more effective positional movement of a hair dryer relative to the hair dryer support device.

### SUMMARY OF THE INVENTION

In view of the foregoing disadvantages inherent in the known types of hair dryer support devices now present in the known art, the present invention provides a hair dryer support device wherein the same can be utilized for providing convenience for the user when styling his or her hair while utilizing a hair dryer.

The present system comprises a base member configured to support a vertical support rod in an upward and perpendicular position. The vertical support rod is defined by a top end and a bottom end, with the bottom end defining a connection point between the base member and the vertical support rod. A bracket is attached to the vertical support rod opposite of the base member. The bracket is defined by a flexible member attached to the vertical support rod. The bracket is defined by a first circular support and a second circular support wherein the first circular support member and second circular support member perpendicularly attach to the distal end of the flexible member at an edge of each of the first circular support member and the second circular support member.

It is therefore an object of the present invention to provide a new and improved hair dryer support device that has all the advantages of the prior art and none of the disadvantages.

Another object of the present invention is to provide a weighted base member configured to provide additional gravitational support to the hair dryer support device.

Yet another object of the present invention is to provide a removable and collapsible vertical support rod to provide a user with an efficient method of deconstructing and transporting the hair dryer support device.

Still yet another object of the present invention is to provide a plurality of fasteners between a plurality of vertical support members of the vertical support rod to enable a user to effectively and securely reconstruct the hair dryer support device.

A further object of the present invention is to provide a threaded fastener between the plurality of vertical support members of the vertical support rod to enable a user to effectively and securely reconstruct the hair dryer support device.

Yet another object of the present invention is to provide a threaded connector on a top surface of the base member to enhance structural support of the hair dryer support device.

Still yet another object of the present invention is to provide a padding member disposed on an internal surface of the first circular support member so as to provide a non-damaging surface for a hair dryer to rest upon.

Yet another object of the present invention is to provide a first circular support member and a second circular support member that are adjustable in circumference, so as to accommodate a hair dryer of any size.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the hair dryer support device.

FIG. 2A shows a close-up view of the bracket of an embodiment of the hair dryer support device.

FIG. 2B shows a close-up view of the bracket of an embodiment of the hair dryer support device wherein a hair dryer is mounted thereon.

FIG. 3 shows a deconstructed view of an embodiment of the hair dryer support device.

FIG. 4 shows a perspective view of the hair dryer support device in use.

### DETAILED DESCRIPTION OF THE INVENTION

Reference is made herein to the attached drawings. Like reference numerals are used throughout the drawings to depict like or similar elements of the hair dryer support device. The figures are intended for representative purposes only and should not be considered to be limiting in any respect.

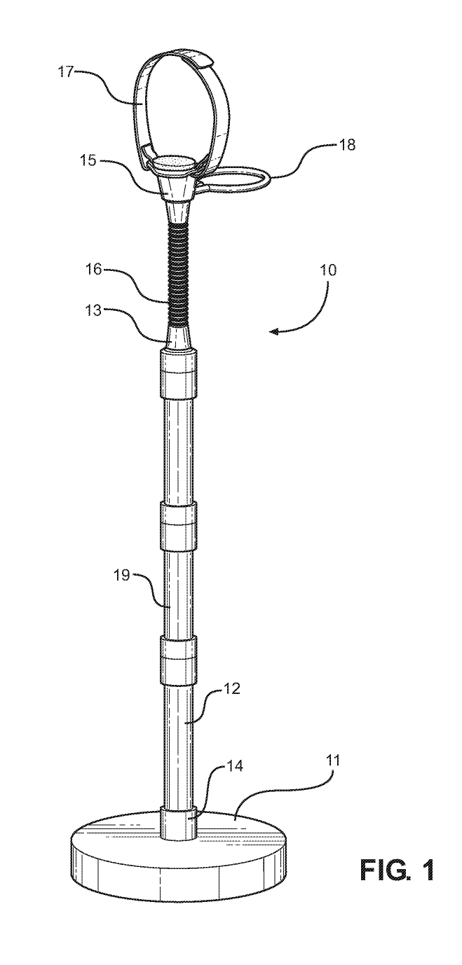

Referring now to FIG. 1, there is shown a perspective view of an embodiment of the hair dryer support device. The hair dryer support device 10 has a base member 11. The base member 11 is configured to support a vertical support rod 12 in an upward position. The upward position is defined as a position perpendicular to a top surface of the base member 11. In one embodiment, the base member 11 is weighted. Weighting the base member 11 prevents tipping over of the hair dryer support device 10 and provides stability to the vertical support rod 12. In another embodiment, the base member 11 comprises a suction cup thereon. The suction cup is configured to secure the base member 11 to a flat surface.

The vertical support rod 12 defines a top end 13 that is positioned opposite of a bottom end 14. The bottom end 14 attaches to the base member 11. A bracket 15 is attached at the top end 13 of the vertical support rod 12. The bracket 15 is attached to the top end 13 of the vertical support rod 12 by a flexible member 16. The flexible member 16 is attached to the bracket 15 at a bottom surface thereof. The bracket 15 has a first circular support member 17 and a second circular support member 18 disposed opposite the flexible member 16. In one embodiment, each of the first circular support member 17 and the second circular support member 18 are adjustable in circumference.

In the shown embodiment, the vertical support rod 12 is defined by a plurality of vertical support members 19. The variable lengths of the arrangement of the plurality of vertical support members 19 allows the user to adjust a vertical height at which the bracket 15 is set. In the shown embodiment, the vertical support rod 12 comprises a first vertical support member a second vertical support member and a third vertical support member.

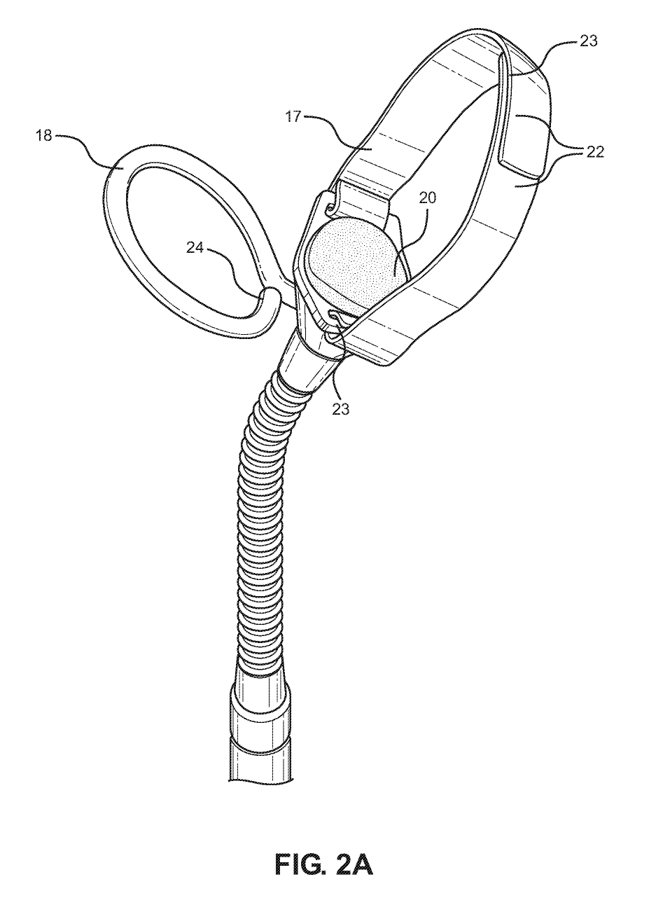

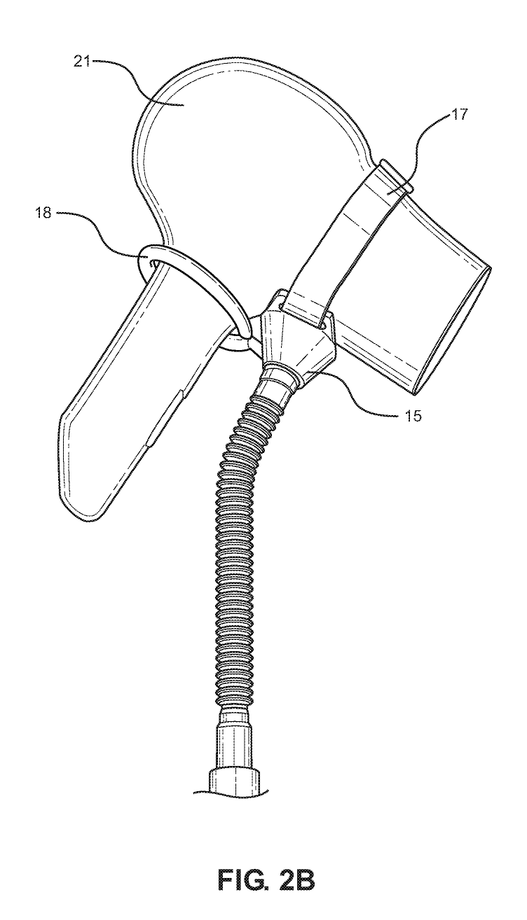

Referring now to FIG. 2A, there is shown a close-up view of the bracket of an embodiment of the hair dryer support device. The first circular support member 17 and the second circular support member 18 are oriented substantially perpendicular to one another. In the shown embodiment, a padding member 20 is disposed on an internal surface of the first circular support member 17.

In the illustrated embodiment, the first circular support member comprises a pair of straps 22 configured to form a circle when a pair of fasteners thereof are engaged. In one embodiment, the pair of fasteners is a pair of hook and loop fasteners. In one embodiment, the pair of straps 22 are attached to the flexible member by a pair of apertures 23 therethrough.

Furthermore, a break 24 is defined in the second circular support member 18. The break 24 provides room by which the circumference of the second circular support member 18 can be adjusted.

Referring now to FIG. 2B, there is shown close-up view of the bracket of an embodiment of the hair dryer support device wherein a hair dryer is mounted thereon. The bracket 15 is configured to receive a hair dryer 21 therein. The first circular support member 17 is sized to receive a barrel of the hair dryer 21. The second circular support member is sized to receive a handle of the hair dryer 21.

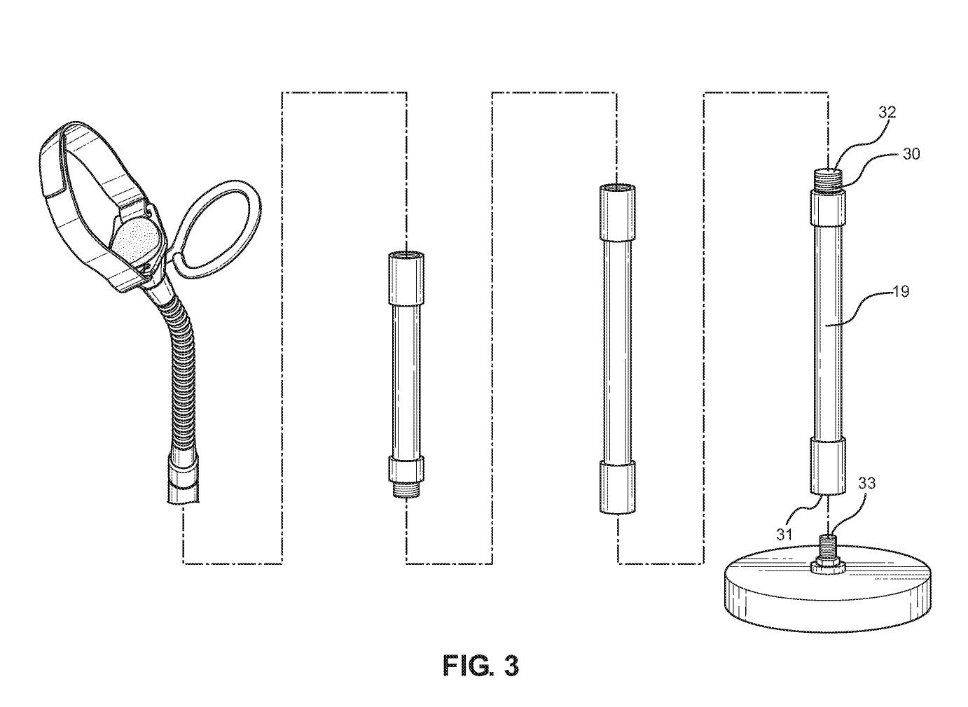

Referring now to FIG. 3, there is shown a deconstructed view of an embodiment of the hair dryer support device. In one embodiment, the vertical support rod is removable and collapsible. When the vertical support rod is collapsible, the plurality of vertical support members 19 are each separable from one another. Each vertical support member 19 defines a first end 30 and a second end 31.

The first end 30 and the second end 31 are removably securable to each other through the action of a fastener. In the shown embodiment, the fastener is defined by corresponding threading 32 on the first end 30 of a vertical support member 19 and the second end 31 of a separate vertical support member 19. Additionally, the base member 11 comprises a connector 33 on which the second end 31 of a lowest vertical support member in the vertical bar is configured to attach.

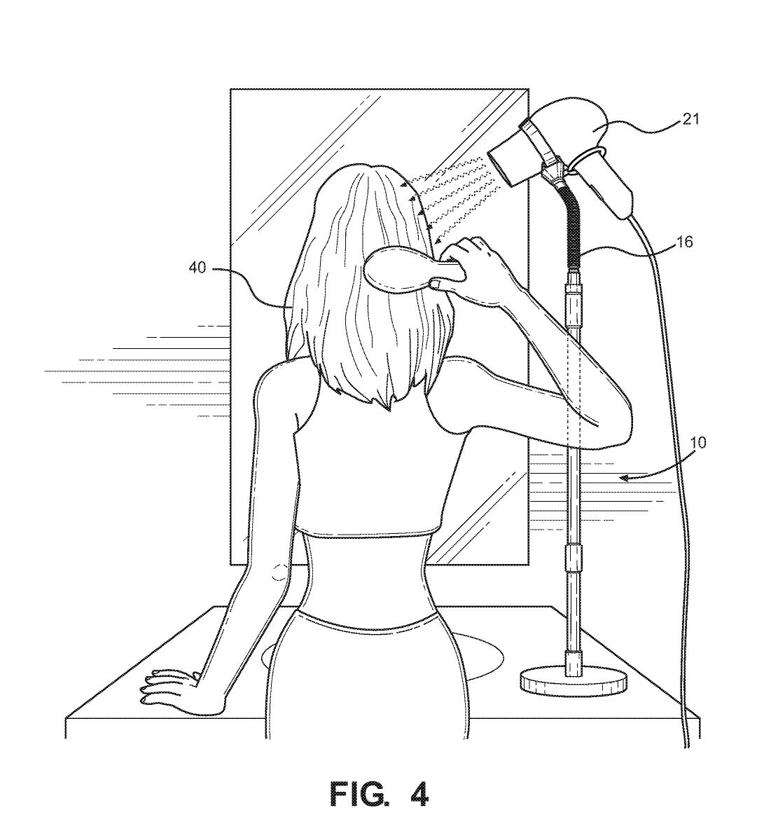

Referring now to FIG. 4, there is shown a perspective view of the hair dryer support device in use. The hair dryer support device 10 is configured to allow a user 40 to set a hair dryer 21 into the bracket 15. When the hair dryer 21 is placed into the bracket, the user 40 can manipulate the flexible member 16 to adjust the positioning of the hair dryer 21. The vertical height of the hair dryer support device 10 is changeable by the addition or removal of vertical support members.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form function and manner of operation, assembly and use are deemed readily apparent and obvious to one skilled in the art, and all equivalent relationships to those illustrated in the drawings and described in the specification are intended to be encompassed by the present invention.

Therefore the foregoing is considered as illustrative only of the principle of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A hair dryer support device, comprising:
a base member configured to support a vertical support rod in an upward and perpendicular position;
the vertical support rod having a top end and a bottom end wherein the bottom end attaches to the base member;
a bracket attached to the top end of the vertical support bar wherein the bracket has a flexible member attached at a bottom surface thereof that is attached to the top end of the vertical support rod; and
the bracket having a first circular support member attached oppositely the flexible member and a second circular support member attached oppositely the flexible member wherein the first circular support member and the second circular support member are oriented perpendicularly.

2) The hair dryer support device of claim 1, wherein the base member is weighted.

3) The hair dryer support device of claim 1, wherein the vertical support rod is removable and collapsible.

4) The hair dryer support device of claim 3, wherein the vertical support rod is comprised of a plurality of vertical support members wherein each vertical support member of the plurality of vertical support members has a first end and a second end wherein the first end and the second end are removably securable by the action of a fastener.

5) The hair dryer support device of claim 4, wherein the first end of each vertical support member and the second end of each separate vertical support member comprise a corresponding threading thereon.

6) The hair dryer support device of claim 3, wherein the base member comprises a connector adapted to receive the bottom end of the vertical support bar thereon.

7) The hair dryer support device of claim 1, wherein a padding member is disposed on an internal surface of the first circular support member.

8) The hair dryer support device of claim 1, wherein the first circular support member and the second circular support member are adjustable in circumference.

9) The hair dryer support device of claim 4, wherein each vertical support member of the plurality of vertical support members is of a different length.

10) The hair dryer support device of claim 4, wherein the plurality of vertical support members comprises a first vertical support member, a second vertical support member and a third vertical support member.
